(19) United States
(12) Patent Application Publication
(10) Pub. No.: US 2024/0037006 A1
(43) Pub. Date: Feb. 1, 2024

(54) DATA ARCHIVING METHOD, ELECTRONIC DEVICE, AND READABLE STORAGE MEDIUM

(71) Applicant: BYD COMPANY LIMITED, Shenzhen (CN)

(72) Inventors: Yongjing ZHU, Shenzhen (CN); Junxian LUO, Shenzhen (CN)

(73) Assignee: BYD COMPANY LIMITED, Shenzhen (CN)

(21) Appl. No.: 18/478,664

(22) Filed: Sep. 29, 2023

Related U.S. Application Data
(63) Continuation of application No. PCT/CN2022/095984, filed on May 30, 2022.

(30) Foreign Application Priority Data
Jun. 23, 2021 (CN) 202110701029.2

(51) Int. Cl. G06F 11/34; G06F 11/07; G06F 11/30

(52) U.S. Cl. CPC G06F 11/3433; G06F 11/3419; G06F 11/0772; G06F 11/3075

(57) ABSTRACT

A data archiving method, an electronic device, and a readable storage medium relate to the field of the database technology. The method includes: acquiring monitoring data collected by at least one monitoring subsystem; storing, according to a preset rule, the monitoring data as multiple data objects corresponding to the monitoring subsystem; controlling a first thread corresponding to the monitoring subsystem to read the data objects into a corresponding data queue according to a preset order; and controlling a second thread corresponding to the monitoring subsystem to write the data objects from the data queue into a database in response to the first thread reading the data objects into the data queue each time.

### CROSS-REFERENCE TO RELATED APPLICATIONS

The present disclosure is a bypass continuation application of PCT International Patent Application No. PCT/CN2022/095984, filed on May 30, 2022, which claims priority to and benefits of Chinese Patent Application No.202110701029.2, entitled “DATA ARCHIVING METHOD, ELECTRONIC DEVICE, AND READABLE STORAGE MEDIUM”, and filed on Jun. 23, 2021, which are incorporated herein by reference in their entireties.

### FIELD

The embodiment of the present disclosure relate to the field of the database technology, and more specifically, to a data archiving method, an electronic device, and a computer-readable storage medium.

### BACKGROUND

In the field of public transportation such as subways and urban rails, the number of monitoring points in an integrated supervisory system is often in the range of tens of thousands to hundreds of thousands. The stored data often involves operational safety, fault tracing, etc. The integrated supervisory system in related arts mostly adopts relational databases such as Oracle, MySql, and MSSQL for data storage. The data storage efficiency of these databases varies according to parameter selection. The data in the integrated supervisory system is separately created offline for each specific public transportation route. The number of monitoring points varies depending on different routes. Moreover, the database server configuration and database parameter selection may vary for each route, which may result in a mismatch between the creating efficiency of monitoring data and the storage efficiency of the databases.

### SUMMARY

Objective of embodiment of the present disclosure is to provide a new technical solution of online data archiving.

In a first aspect, the present disclosure provides a data archiving method, which includes: Monitoring data collected by at least one monitoring subsystem is acquired. The monitoring data is stored as multiple data objects corresponding to the monitoring subsystem according to a preset rule. A first thread corresponding to the monitoring subsystem is controlled to read the data objects into a corresponding data queue according to a preset order. When the first thread reads the data objects into the data queue each time, a second thread corresponding to the monitoring subsystem is controlled to write the data objects from the data queue into a database.

In a second aspect, the present disclosure provides an electronic device, including a memory and a processor. The processor is configured to store a computer program. The processor is configured to execute the computer program so as to implement the method in the first aspect of the present disclosure.

In a third aspect, the present disclosure provides a computer-readable storage medium, storing a computer program. The computer program, when executed by a processor, implements the method in the first aspect of the present disclosure.

Other features and advantages of the embodiments of the present disclosure will become apparent from the following detailed description of exemplary embodiments of the present disclosure with reference to the accompanying drawings.

### BRIEF DESCRIPTION OF THE DRAWINGS

Accompanying drawings incorporated in and forming a part of this specification illustrate the embodiments of the present disclosure and, together with the description thereof, are used to explain the principles of the embodiments of the present disclosure.

FIG. 1 is a schematic block diagram of hardware configuration of an electronic device according to an embodiment of the present disclosure;

FIG. 2 is a block diagram of an electronic device according to an embodiment of the present disclosure;

FIG. 3 is a schematic flowchart of a data archiving method according to an embodiment of the present disclosure;

FIG. 4 is a schematic diagram of processing data objects by a database archiving service module according to an embodiment of the present disclosure;

FIG. 5 is a schematic flowchart of an example of a data archiving method according to an embodiment of the present disclosure;

FIG. 6 is a schematic flowchart of an example of a data archiving method according to another embodiment of the present disclosure; and

FIG. 7 is a schematic diagram of a hardware structure of an electronic device according to another embodiment of the present disclosure.

### DETAILED DESCRIPTION

Various exemplary embodiments of the present disclosure are now described in detail with reference to the accompanying drawings. It is to be noted that, unless otherwise specified, opposite arrangement, numerical expressions, and numerical values of components and steps described in the embodiments do not limit the scope of the present disclosure.

The following descriptions of at least one exemplary embodiment are merely illustrative, and in no way constitute any limitation on the present disclosure and application or use of the present disclosure.

Technologies, methods, and devices known to those of ordinary skill in related arts may not be discussed in detail, but where appropriate, the technologies, the methods, and the devices should be considered as a part of the specification.

In all embodiments shown and discussed herein, any specific value should be construed as merely exemplary and not as limitations. Therefore, other examples of the exemplary embodiments may have different values.

It is to be noted that, similar numerals and letters denote similar items in the following figures, once an item is defined in a figure, it is unnecessary to further discuss the item in the subsequent figures.

### Hardware Configuration

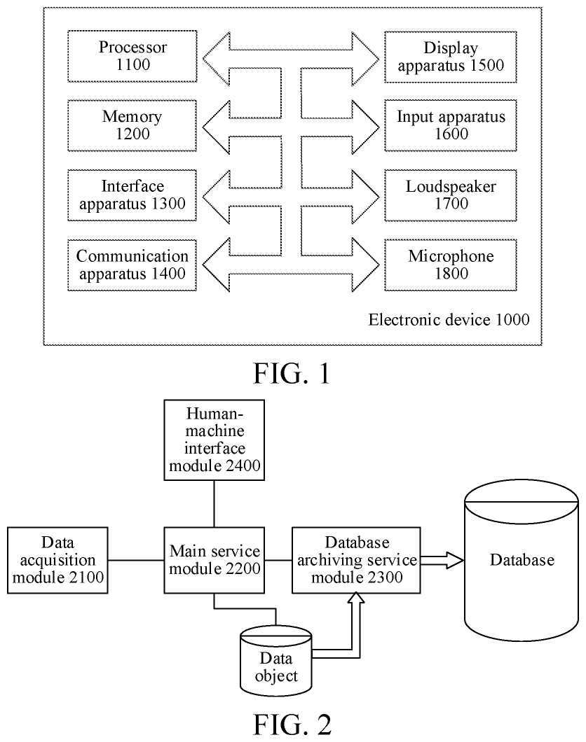

FIG. 1 is a structural schematic diagram of an electronic device according to an embodiment of the present disclosure.

The electronic device 1000 may be a smart phone, a laptop, a desk computer, a tablet, a server, etc., which is not limited herein.

The electronic device 1000 may include but not limited to a processor 1100, a memory 1200, an interface apparatus 1300, a communication apparatus 1400, a display apparatus 1500, an input apparatus 1600, a loudspeaker 1700, a microphone 1800, etc. The processor 1100 may be a central processing unit (CPU), a graphics processing unit (GPU), a microcontroller unit (MCU), and is configured to perform computer programs, and the computer programs may be compiled by an instruction set adopting architectures such as x86, Arm, RISC, MIPS, and SSE. The memory 1200 may include a read only memory (ROM), a random access memory (RAM), and a nonvolatile memory such as hard disk, etc. The interface apparatus 1300 may include a universal serial bus (USB) interface, a serial interface, a parallel interface, etc. The communication apparatus 1400 may adopt an optical cable or a cable to perform wired communication or wireless communication, specifically including WiFi communication, bluetooth communication, and 2G/3G/4G/5G communication. The display apparatus 1500 may be a liquid crystal display, a touch screen, etc. The input apparatus 1600 may include the touch screen, a keyboard, a gesture-based input, etc. The loudspeaker 1700 is configured to output audio signals. The microphone 1800 is configured to collect the audio signals.

In an embodiment of the present disclosure, the memory 1200 of the electronic device 1000 is configured to store a computer program. The computer program is used for controlling the processor 1100 to perform operation, thereby implementing a method according to this embodiment of the present disclosure. Technical personnel can design the computer program based on a solution disclosed by the present disclosure. How the computer program controls the processor to operate is well-known in the art, which is not described in detail here. The electronic device 1000 may be equipped with a smart operating system (e.g., Windows, Linux, Android, and iOS), and application software.

Those skilled in the art should understand that, although multiple apparatuses of the electronic device 1000 are shown in FIG. 1, the electronic device 1000 in this embodiment of the present disclosure may only involve some of these apparatuses, such as only the processor 1100 and the memory 1200.

Various embodiments and examples according to the present disclosure are described with reference to accompanying drawings as below.

### Method Embodiments

FIG. 2 is a block diagram of an electronic device according to an embodiment. As shown in FIG. 2, the electronic device 2000 may include a data acquisition module 2100, a main service module 2200, a database archiving service module 2300, and a human-machine interface module 2400.

The data acquisition module 2100 is configured to acquire monitoring data collected by external monitoring subsystems, and transmit the monitoring data to the main service module 2200. The main service module 2200 caches the monitoring data as data files in time order, and stores the data files on a local disk in time order. The database archiving service module 2300 splits the data file corresponding to each monitoring subsystem into multiple data objects, controls a first thread corresponding to each monitoring subsystem in time order to read the corresponding data objects into a corresponding data queue, and then controls a second thread corresponding to each monitoring subsystem to write the data objects from the corresponding data queue into a database.

The database archiving service module 2300 can further calculate a storage load rate corresponding to each monitoring subsystem to respectively determine whether the storage load rate corresponding to each monitoring subsystem meets alarm conditions or not, and feeds an alarm message to the main service module 2200 when the storage load rate corresponding to each monitoring subsystem meets the alarm conditions. The main service module 2200 reports the alarm message to the human-machine interface module 2400. The human-machine interface module 2400 displays the alarm message for user checking, and allows manual intervention in a data archiving process based on the alarm message.

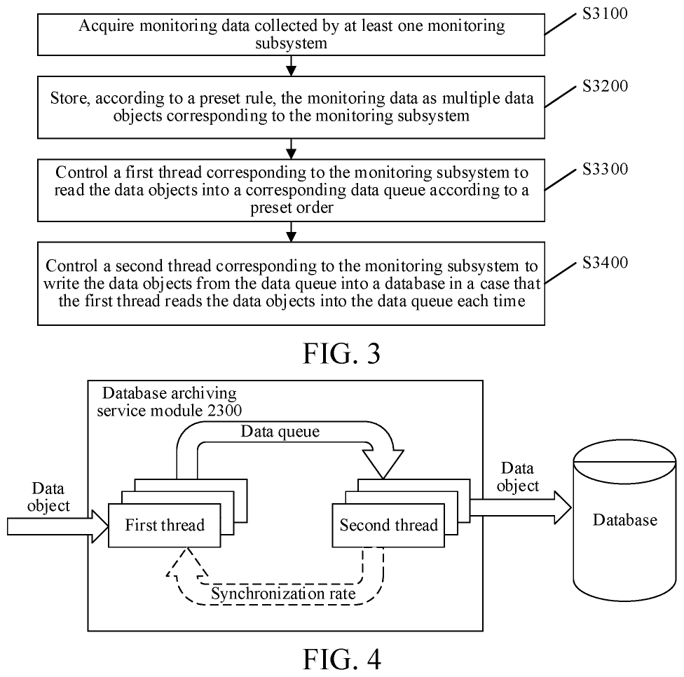

FIG. 3 is a schematic flowchart of a data archiving method according to an embodiment. The embodiment may be implemented by an electronic device. For example, the electronic device may be the electronic device 1000 shown in FIG. 1.

As shown in FIG. 3, the data archiving method in this embodiment may include following shown steps S3100 to S3400.

Step S3100: Monitoring data collected by at least one monitoring subsystem is acquired.

In an embodiment, in the field of public transportation such as subways, urban rails, and buses, the monitoring subsystem may be a passenger service monitoring system, a station device monitoring system, a train operation control monitoring system, a fire alarm monitoring system, or a power supply monitoring system, etc. Each monitoring subsystem may be composed of at least one corresponding monitoring device, and each monitoring device has at least one monitoring point.

The monitoring data collected by the monitoring subsystem may include point value information of the monitoring point of the corresponding monitoring device, and acquisition time.

Step S3200: According to a preset rule, the monitoring data is stored as multiple data objects corresponding to the monitoring subsystem.

In an embodiment of the present disclosure, the step that according to a preset rule, the monitoring data is stored as multiple data objects corresponding to the monitoring subsystem may include following shown steps S3210 to S3220.

Step S3210: According to a preset first time interval, the monitoring data is stored as data files corresponding to the monitoring subsystem.

The first time interval in this embodiment may be preset according to an application scenario or specific requirements. For example, the first time interval may be 10 minutes. In this case, the monitoring data collected by one of the monitoring subsystems every 10 minutes may be stored as a data file corresponding to that monitoring subsystem. In other words, the time span corresponding to each data file is equal to the first time interval. Moreover, the size of the data file may be determined by the first time interval.

In an embodiment, storing the monitoring data as data files corresponding to the monitoring subsystem may be storing the monitoring data as database files, such as *.db files.

In some embodiments, a configuration interface may be provided in advance. The configuration interface includes a first input box used for inputting the first time interval, and the user may set the first time interval through the first input box.

In some embodiments, the monitoring data acquired in step S3100 may be cached in an internal memory of the electronic device. The monitoring data is stored as data files. The data files may be stored in a disk of the electronic device. When the electronic device is a distributed computer cluster, the data files may be stored in the disk of a computer, performing step S3210, in the distributed computer cluster.

When the monitoring data acquired in step S3100 is collected by multiple monitoring subsystems, the monitoring data collected by each monitoring subsystem may be separately stored as a data file corresponding to each monitoring subsystem according to the first time interval.

In an embodiment of the present disclosure, the configuration interface includes a second input box used for inputting a cache window. The user may set the cache window by the second input box. The cache window may represent the total number of cached data files in the disk, namely, the maximum data caching capacity.

The cache window may be defined in units of time. For example, the cache window may be set to 7 days, which means that the disk may cache data files cached within the last 7 days.

In an embodiment, it is unnecessary to additionally adjust the cache window according to a specific public transportation route or data, and only one universal value is required to be set. By setting the cache window, the dependency on manual data archiving can be reduced.

Step S3220: The data file is split into multiple data objects according to a preset second time interval.

The second time interval in an embodiment may be preset according to an application scenario or specific requirements, and may also be set according to the actual storage capacity of the database. The second time interval may be smaller than the first time interval. For example, the second time interval may be 1 min. In this case, the data file within the time span of 10 minutes may be split into 10 data objects separately within the time span of 1 min.

In some embodiments, each obtained data object may have at least a corresponding start time, and may also have a corresponding end time.

In this embodiment, by splitting the data file corresponding to each monitoring subsystem, the data objects corresponding to each monitoring subsystem can be obtained.

Step S3300: A first thread corresponding to the monitoring subsystem is controlled to read the data objects into a corresponding data queue according to a preset order.

In an embodiment, the first thread and the data queue corresponding to each monitoring subsystem may be preset. The first thread corresponding to each monitoring subsystem is controlled to read the corresponding data objects into the corresponding data queue according to the preset order.

The preset order in this embodiment may be specifically a time order. Specifically, the first thread of any monitoring subsystem may read the earliest data object, which has not been read before, from the data objects corresponding to the monitoring subsystem into the corresponding data queue.

Step S3400: When the first thread reads the data objects into the data queue each time, a second thread corresponding to the monitoring subsystem is controlled to write the data objects from the data queue into the database.

In an embodiment, the second thread queue corresponding to each monitoring subsystem may be preset. The second thread of each monitoring subsystem may be controlled to write the data objects from the data queue into the database.

Specifically, the second thread may write, according to a read order of the data objects from the data queue, the data objects into the database.

In an embodiment, in the database archiving service module, the way in which the first thread reads the data objects into the data queue and the way in which the second thread writes the data objects from the data queue into the database may be, for example, shown in FIG. 4.

In an embodiment of the present disclosure, a data queue corresponding to each monitoring subsystem may include at most one data object. In this case, when the second thread has written the data objects from the data queue, the first thread is controlled to read a next data object into the data queue.

In other words, once the second thread completes writing of the data object which is read by the first thread into the data queue at this time, meaning that all data objects are written into the database, the first thread initiates the next read step and reads the next data object into the data queue.

According to an embodiment of the present disclosure, detection data collected by each monitoring subsystem is stored as the corresponding data objects. The first thread is controlled to read the data objects corresponding to the monitoring subsystem into the data queue. Then, the second thread is controlled to write the data objects from the data queue into the database. Thus, the read-write rate of the data objects corresponding to at least one monitoring subsystem can be improved at the same time. Moreover, by setting the data queue, the rate of reading the data objects by the first thread can be synchronously controlled according to the rate at which the second thread writes to the database, such that the write rate of the second thread is synchronized with the read rate of the first thread. In addition, the problem of data loss caused by excessive accumulation of unprocessed data objects in the data queue may also be solved.

In an embodiment of the present disclosure, the method may further include following shown steps S3500 to S3700.

Step S3500: A storage load rate corresponding to the monitoring subsystem is acquired in a process of reading the data objects at this time.

The storage load rate is a parameter for measuring whether the read rate and the write rate for the data objects of the monitoring subsystem are balanced or not. The read rate refers to the rate at which the first thread reads the data objects into the data queue. The write rate refers to the rate at which the second thread writes the data objects into the database.

In an embodiment of the present disclosure, the step that a storage load rate corresponding to the monitoring subsystem is acquired in a process of reading the data objects at this time may include following shown steps S3510 to S3530.

Step S3510: A first start time of the data object read by the first thread at this time, and a second start time of a data object read by the first thread last time are read.

The start time refers to the time when acquisition of the corresponding data object is started, and includes the first start time and the second start time. That is, the first start time refers to the time when acquisition of the data object read by the first thread at this time is started. The second start time refers to the time when acquisition of the data object read by the first thread last time is started.

In an embodiment, when the data object is obtained, the start time of the data object may also be obtained.

Step S3520: A first system time when the first thread starts to perform operation of reading the data object at this time, and a second system time when the first thread starts to perform operation of reading the data object last time are obtained.

In an embodiment, the system time may be a local time of the electronic device, and may also be an Internet time. The first system time may be the system time when the first thread starts to perform the operation of reading the data object at this time. The second system time may be the system time when the first thread starts to perform the operation of reading the data object last time.

Step S3530: The storage load rate is determined according to the first start time, the second start time, the first system time, and the second system time.

In an embodiment of the present disclosure, the step that the storage load rate is determined according to the first start time, the second start time, the first system time, and the second system time may include following shown steps S3531 to S3533.

Step S3531: A time difference between the first start time and the second start time is determined as a first time difference.

For example, the first start time may be denoted by T_data_cur, the second start time may be denoted by T_data_pre, and thus, the first time difference T1 may be obtained through a Formula I below.

T1=T_data_cur-T_data_pre (Formula I)

Step S3532: A time difference between the first system time and the second system time is determined as a second time difference.

For example, the first system time may be denoted by T_oper_cur, the second system time may be denoted by T_oper_pre, and thus, the second time difference T2 may be obtained through a Formula II below.

T2=T_oper_cur-T_oper_pre (Formula II)

Step S3533: A ratio of the second time difference to the first time difference is determined as a storage load rate.

The storage load rate P may be obtained by a Formula III below.

P=T2/T1 (Formula III)

In an embodiment of the present disclosure, the storage load rate corresponding to the monitoring subsystem may be acquired in the process of reading the data objects by the first thread each time.

Step S3600: Whether the storage load rate corresponding to the monitoring subsystem meets preset alarm conditions or not is determined.

In an embodiment of the present disclosure, the step that whether the storage load rate corresponding to the monitoring subsystem meets preset alarm conditions or not is determined may include following shown steps S3610 to S3630.

Step S3610: Whether the storage load rate corresponding to the monitoring subsystem acquired in the process of reading the data objects by the first thread at this time exceeds a preset threshold or not is determined.

The preset threshold may be preset according to an application scenario or specific requirements. For example, the threshold may be 1.

The storage load rate does not exceed the threshold, which indicates that the efficiency of writing the data objects from the data queue into the database in the process of reading the data objects by the first thread at this time is sufficient to meet the efficiency of reading the data objects into the data queue.

The storage load rate exceeds the threshold, which indicates that the efficiency of writing the data objects from the data queue into the database in the process of reading the data objects by the first thread at this time is insufficient to meet the efficiency of reading the data objects into the data queue, and as a result, the data queue will cause the phenomenon of data accumulation.

Step S3620: When the storage load rate exceeds the threshold, whether the number of consecutive times the storage load rate corresponding to the monitoring subsystem exceeds a preset count threshold or not is determined.

In the process of reading the data objects by the first thread last time, the storage load rate corresponding to the monitoring subsystem exceeds the threshold, and the consecutive times corresponding to the process of reading the data objects by the first thread last time is n, if the storage load rate corresponding to the monitoring subsystem exceeds the threshold in the process of reading the data objects by the first thread at this time exceeds the threshold, the consecutive times corresponding to the process of reading the data objects by the first thread at this time is n+1. If the storage load rate corresponding to the monitoring subsystem does not exceed the threshold in the process of reading the data objects by the first thread at this time, the consecutive times corresponding to the process of reading the data objects by the first thread at this time is 0.

The count threshold in this embodiment may be preset according to an application scenario or specific requirements. For example, the count threshold may be 3.

Step S3630: When the consecutive times exceed the count threshold, it is determined that the database meets the alarm conditions.

The storage load rate corresponding to the monitoring subsystem exceeds the threshold in the process of reading the data objects by the first thread at a time, which only indicates a transient state of a database storage load. It is possible that the data objects read into the data queue are relatively dense, and the rate at which the data objects are read into the data queue may be reduced next time. The storage load rate corresponding to the monitoring subsystem exceeds the threshold, and then can further be lower than or equal to the threshold. Thus, the corresponding storage load rate of the monitoring subsystem in the process of reading at a time exceeds the threshold, which cannot indicate unbalanced throughput of the database.

In an embodiment, the database meeting the alarm conditions is judged when the consecutive times of the storage load rate corresponding to the monitoring subsystem exceeding the threshold is greater than the count threshold, thereby solving the problem of false alarms.

Step S3700: An alarm is given when a monitoring submodule meets the alarm conditions.

In an embodiment of the present disclosure, when the database meets the alarm conditions, a manner of giving the alarm may be: generating an alarm message, and displaying the alarm message through an interface.

In an embodiment of the present disclosure, the content of the alarm message may include: the storage load rate of the monitoring subsystem determined last time; and/or, names of top N monitoring points in terms of memory space from the data objects of the monitoring subsystem read last time, as well as storage proportions of these monitoring points within the monitoring subsystem.

The content of the alarm message can guide data producers to adjust allocation data in time, and make targeted modifications to the configuration of specific monitoring points, which has a positive practical significance for monitoring deployment of the whole public transportation route, and meanwhile has an important significance for actual online operation of the public transportation route. Specifically, if there are frequent anomalies in monitoring data collection, or a decline in database storage performance, the alarm message can also alert operators to find storage issues in time during running.

In an embodiment of the present disclosure, by calculating the database storage load rate of each monitoring subsystem, an automatic feedback mechanism is added among data collection, data caching, and database storage, which can reduce reliance on human experience, and make data archiving more convenient. Moreover, the archiving service cannot pause in the archiving process, which can avoid the loss of the monitoring data.

In an embodiment of the present disclosure, the step that an alarm is given when the database meets alarm conditions may include following shown steps S3710 to S3720.

Step S3710: An alarm level is determined according to the consecutive times when the database meets the alarm conditions.

In an embodiment of the present disclosure, multiple frequency ranges and the alarm level corresponding to each frequency range may be preset according to an application scenario or specific requirements. For example, the multiple frequency ranges may include: greater than or equal to 3 and less than 5, greater than or equal to 5 and less than or equal to 10, and greater than 10. The alarm level corresponding to the frequency range being greater than or equal to 3 and less than 5 may be a low level. The alarm level corresponding to the frequency range being greater than or equal to 5 and less than or equal to 10 may be a medium level. The alarm level corresponding to the frequency range being greater than 10 may be a high level.

In an embodiment, determining the alarm level according to the consecutive times may be determining the alarm level corresponding to the frequency range associated with the consecutive times.

For example, when the consecutive times is 4, the consecutive times is within the frequency range being greater than or equal to 3 and less than 5, and thus, the corresponding alarm level is the low level.

For another example, when the consecutive times is 8, the consecutive times is within the frequency range being greater than or equal to 5 and less than or equal to 10, and thus, the corresponding alarm level is the medium level.

Step S3720: A corresponding alarm is given according to the alarm level.

In an embodiment of the present disclosure, the manner of giving the corresponding alarm according to the alarm level may be displaying the alarm message by a color corresponding to the alarm level.

The color corresponding to each alarm level may be preset according to an application scenario or specific requirements. For example, the color corresponding to the low level may be yellow. The color corresponding to the medium level may be orange. The color corresponding to the high level may be red.

Specifically, the text content of the alarm message may be displayed by the color corresponding to the alarm level, or a message box of the alarm message may be displayed through highlight of the color corresponding to the alarm level.

In another embodiment of the present disclosure, the manner of giving the corresponding alarm according to the alarm level may be adding the alarm level to the alarm message for display.

### EXAMPLE 1

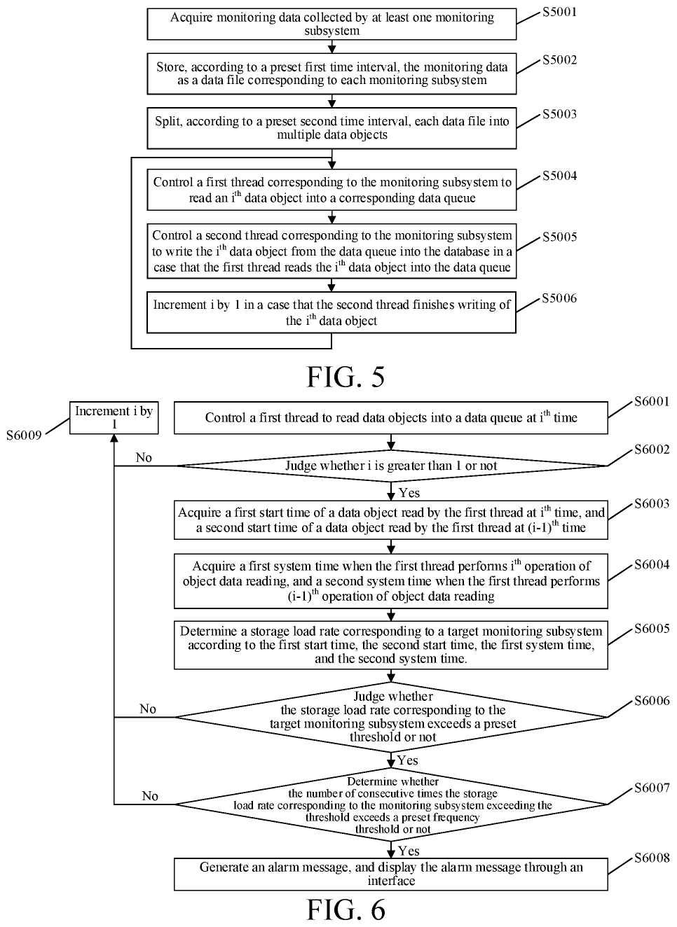

FIG. 5 is a schematic flowchart of an example of a data archiving method according to an embodiment of the present disclosure.

As shown in FIG. 5, the method may include the following shown steps S5001 to step S5006.

Step S5001: Monitoring data collected by at least one monitoring subsystem is acquired.

Step S5002: According to a preset first time interval, the monitoring data is stored as data files corresponding to each monitoring subsystem.

Step S5003: Each data file is split into multiple data objects according to a preset second time interval.

Step S5004: A first thread corresponding to the monitoring subsystem is controlled to read an i^{th} data object into a corresponding data queue,
where i is a positive integer.

Step S5005: When the first thread reads the i^{th} data object into the data queue, a second thread corresponding to the monitoring subsystem is controlled to write the i^{th} data object from the data queue into the database.

Step S5006: When the second thread finishes writing of the i^{th} data object, i is incremented by 1.

After step S5006 is performed, continue performing step S5004.

### EXAMPLE 2

Based on the above Example 1, in this embodiment, archiving monitoring data collected for a target monitoring subsystem is taken as an example to describe the data archiving method of the present disclosure.

The data archiving method may further include following steps S6001 to S6009 shown in FIG. 6.

Step S6001: A first thread is controlled to read data objects into a data queue at i^{th} time, where i is a positive integer.

Step S6002: Whether i is greater than 1 or not is judged, if yes, step S6003 is performed; and if not, step S6009 is performed.

Step S6003: A first start time of a data object read by the first thread at i^{th} time, and a second start time of a data object read by the first thread at (i−1)^{th} time are obtained.

Step 6004: A first system time when the first thread performs i^{th} operation of data object reading, and a second system time when the first thread performs (i−1)^{th} operation of data object reading are obtained.

Step S6005: A storage load rate corresponding to the target monitoring subsystem is determined according to the first start time, the second start time, the first system time, and the second system time.

Step S6006: Whether the storage load rate corresponding to the target monitoring subsystem exceeds a preset threshold or not is judged and determined, if yes, step S6007 is performed; and if not, step S6009 is performed.

Step S6007: Whether the number of consecutive times the storage load rate corresponding to the monitoring subsystem exceeding the threshold exceeds a preset count threshold or not is determined, if yes, step S6008 is performed; and if not, step S6009 is performed.

Step S6008: An alarm message is generated, and displayed through an interface.

Step S6009: i is incremented by 1.

### Device Embodiment

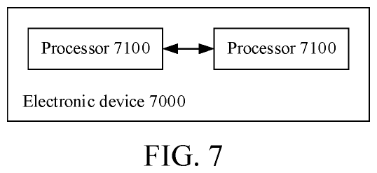

FIG. 7 is a schematic diagram of a hardware structure of an electronic device according to another embodiment.

As shown in FIG. 7, the electronic device 7000 includes a processor 7100 and a memory 7200. The memory 7200 is configured to store an executable computer program. The processor 7100 is configured to perform, according to control of the computer program, the method of any above method embodiment.

The electronic device 7000 may be a smart phone, a laptop, a desk computer, a tablet, a server, a distributed computer cluster, or other electronic device.

Various modules of the electronic device 7000 may be implemented by the processor 7100 performing the computer program stored in the memory 7200 in this embodiment, and may also be implemented by other circuit structures, which is not limited herein.

### Computer-Readable Storage Medium Embodiment

An embodiment provides a computer-readable storage medium storing an executable command. The executable command, when executed by a processor, implements the method described in any method embodiment of the specification.

The present disclosure may be a system, a method and/or computer program product. The computer program product may include a computer-readable storage medium carrying computer-readable program instructions for a processor to implement various aspects of the present disclosure.

The computer-readable storage medium may be a tangible device that may retain and store instructions used by an instruction-executing device. The computer-readable storage medium may be, for example, but is not limited to, an electric storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard disk, a random access memory (RAM), a read only memory (ROM), an erasable programmable read only memory (EPROM or flash memory), a static random access memory (SRAM), a portable compact disk read only memory (CD-ROM),a digital versatile disc (DVD), a memory stick, a floppy disk, a mechanical encoding device, such as a punch card or a raised structure in a groove with instructions stored thereon, or any suitable combination of the above. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from the computer-readable storage medium to various computing/processing devices or downloaded to an external computer or external storage device over a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives the computer-readable program instructions from the network and forwards the computer-readable program instructions for storage in the computer-readable storage medium in each computing/processing device.

The computer program instructions for executing the operation of the present disclosure may be assembly instructions, instruction set architecture (ISA) instructions, machine instructions, machine-dependent instructions, microcode, firmware instructions, status setting data, or source code or object code written in any combination of one or more programming languages. The programming languages include object-oriented programming languages such as Smalltalk and C++, and conventional procedural programming languages such as the C language or similar programming languages. The computer-readable program instructions may be executed entirely on a user computer, partly on the user computer, as a stand-alone software package, partly on the user computer and partly on a remote computer, or entirely on a remote computer or a server. For the case involving the remote computer, the remote computer may be connected to the user computer through any type of network including a local area network (LAN) or a wide area network (WAN), or may be connected to an external computer (e.g., through the Internet by using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

Various aspects of the present disclosure are described herein with reference to flowcharts and/or block diagrams of the method, the apparatus (system), and the computer program product according to the embodiments of the present disclosure. It is to be understood that each block of the flowcharts and/or the block diagrams, and combinations of blocks in the flowcharts and/or the block diagrams may be implemented by the computer-readable program instructions.

These computer-readable program instructions may be provided to a processor of a general-purpose computer, a special-purpose computer, or another programmable data processing apparatus, thereby producing a machine, such that these instructions, when executed by the processor of the computer or the another programmable data processing apparatus, produce apparatuses for implementing functions/actions specified in one or multiple blocks in the flowcharts and/or block diagrams. These computer-readable program instructions may also be stored in the computer-readable storage medium, and these instructions make the computer, the programmable data processing apparatus, and/or another device operate in a specific manner; and thus, the computer-readable medium having instructions stored includes an article of manufacture that includes instructions for implementing various aspects of the functions/actions specified in one or the multiple blocks in the flowcharts and/or block diagrams.

The computer-readable program instructions may also be loaded to the computer, the another programmable data processing apparatus, or the another device, such that a series of operating steps are performed on the computer, the another programmable data processing apparatus, or the another device to produce a computer-implemented process, and accordingly, the instructions executed on the computer, the another programmable data processing apparatus, or the another device implement the functions/actions specified in one or the multiple blocks in the flowcharts and/or block diagrams.

The flowcharts and block diagrams in the accompanying drawings illustrate the architectures, functions, and operations possibly implemented by the system, the method and the computer program product according to various embodiments of the present disclosure. In this regard, each block in the flowcharts or block diagrams may represent a module, a program segment, or part of an instruction, and the module, program segment, or part of the instruction includes one or multiple executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on involved functions. It is to be further noted that each block in the block diagrams and/or flowcharts as well as a combination of the blocks in the block diagrams and/or flowcharts may be implemented by using a dedicated hardware-based system that executes specified functions or actions, or using a combination of special hardware and computer instructions. It is well-known to those skilled in the art that implementing through hardware or software, and through a combination of the software and the hardware are equivalent.

The embodiments of the present disclosure have been described above. The above description is illustrative, rather than exhaustive, and is not limited to the disclosed various embodiments. Numerous modifications and alterations are apparent to those of ordinary skill in the art without departing from the scope and spirit of the illustrated embodiments. The selection of terms as used herein is intended to best explain the principles and practical applications of the various embodiments, or improvements to technologies on the market, or to enable other persons of ordinary skill in the art to understand the various embodiments disclosed herein. The scope of the present disclosure is limited by the appended claims.

What is claimed is:

1. A data archiving method, comprising:
acquiring monitoring data collected by at least one monitoring subsystem;
storing, according to a preset rule, the monitoring data as a plurality of data objects corresponding to the monitoring subsystem;
controlling a first thread corresponding to the monitoring subsystem to read the data objects into a corresponding data queue according to a preset order; and
controlling a second thread corresponding to the monitoring subsystem to write the data objects from the data queue into a database in response to the first thread reading the data objects into the data queue each time.

2. The method according to claim 1, further comprising:
controlling the first thread to read a next data object into the data queue in response to the second thread finishing writing of the data objects from the data queue.

3. The method according to claim 2, further comprising:
acquiring a storage load rate corresponding to the monitoring subsystem in the process of reading data objects by the first thread at this time, wherein the storage load rate is a parameter for measuring whether the read rate and the write rate for the data objects of the monitoring subsystem are balanced or not;
determining whether the storage load rate meets preset alarm conditions or not; and
giving an alarm in response to the storage load rate meeting the alarm conditions.

4. The method according to claim 3, wherein the acquiring a storage load rate corresponding to the monitoring subsystem in the process of reading data objects by the first thread at this time comprises:
acquiring a first start time of the data object read by the first thread at this time, and a second start time of a data object read by the first thread last time, wherein the start time referring to the time when acquisition of the corresponding data object is started;
acquiring a first system time when the first thread starts to perform operation of reading the data object at this time, and a second system time when the first thread starts to perform operation of reading the data object last time; and
determining the storage load rate according to the first start time, the second start time, the first system time, and the second system time.

5. The method according to claim 4, wherein the determining the storage load rate according to the first start time, the second start time, the first system time, and the second system time comprises:
determining a time difference between the first start time and the second start time as a first time difference;
determining a time difference between the first system time and the second system time as a second time difference; and
determining a ratio of the second time difference to the first time difference as the storage load rate.

6. The method according to claim 3, wherein the determining whether the storage load rate meets preset alarm conditions or not comprises:
determining the storage load rate corresponding to the monitoring subsystem exceeds consecutive times of a preset threshold; and
determining that the storage load rate meets the alarm conditions in response to the consecutive times exceeding the preset count threshold.

7. The method according to claim 6, wherein the giving an alarm in response to the storage load rate meeting the alarm conditions comprises:
determining an alarm level according to the consecutive times in response to the storage load rate meeting the alarm conditions; and
giving a corresponding alarm according to the alarm level.

8. The method according to claim 4, wherein the determining whether the storage load rate meets preset alarm conditions or not comprises:
determining the storage load rate corresponding to the monitoring subsystem exceeds consecutive times of a preset threshold; and
determining that the storage load rate meets the alarm conditions in response to the consecutive times exceeding the preset count threshold.

9. The method according to claim 8, wherein the giving an alarm in response to the storage load rate meeting the alarm conditions comprises:
determining an alarm level according to the consecutive times in response to the storage load rate meeting the alarm conditions; and
giving a corresponding alarm according to the alarm level.

10. The method according to claim 5, wherein the determining whether the storage load rate meets preset alarm conditions or not comprises:
determining the storage load rate corresponding to the monitoring subsystem exceeds consecutive times of a preset threshold; and
determining that the storage load rate meets the alarm conditions in response to the consecutive times exceeding the preset count threshold.

11. The method according to claim 10, wherein the giving an alarm in response to the storage load rate meeting the alarm conditions comprises:
determining an alarm level according to the consecutive times in response to the storage load rate meeting the alarm conditions; and
giving a corresponding alarm according to the alarm level.

12. The method according to claim 1, wherein the storing, according to a preset rule, the monitoring data as a plurality of data objects corresponding to the monitoring subsystem comprising:
storing, according to a preset first time interval, the monitoring data as a data file corresponding to the monitoring subsystem; and
splitting, according to a preset second time interval, the data file into a plurality of data objects.

13. The method according to claim 2, wherein the storing, according to a preset rule, the monitoring data as a plurality of data objects corresponding to the monitoring subsystem comprising:
storing, according to a preset first time interval, the monitoring data as a data file corresponding to the monitoring subsystem; and
splitting, according to a preset second time interval, the data file into a plurality of data objects.

14. The method according to claim 3, wherein the storing, according to a preset rule, the monitoring data as a plurality of data objects corresponding to the monitoring subsystem comprising:
storing, according to a preset first time interval, the monitoring data as a data file corresponding to the monitoring subsystem; and
splitting, according to a preset second time interval, the data file into a plurality of data objects.

15. The method according to claim 4, wherein the storing, according to a preset rule, the monitoring data as a plurality of data objects corresponding to the monitoring subsystem comprising:
storing, according to a preset first time interval, the monitoring data as a data file corresponding to the monitoring subsystem; and
splitting, according to a preset second time interval, the data file into a plurality of data objects.

16. The method according to claim 5, wherein the storing, according to a preset rule, the monitoring data as a plurality of data objects corresponding to the monitoring subsystem comprising:
storing, according to a preset first time interval, the monitoring data as a data file corresponding to the monitoring subsystem; and
splitting, according to a preset second time interval, the data file into a plurality of data objects.

17. The method according to claim 6, wherein the storing, according to a preset rule, the monitoring data as a plurality of data objects corresponding to the monitoring subsystem comprising:
storing, according to a preset first time interval, the monitoring data as a data file corresponding to the monitoring subsystem; and
splitting, according to a preset second time interval, the data file into a plurality of data objects.

18. The method according to claim 7, wherein the storing, according to a preset rule, the monitoring data as a plurality of data objects corresponding to the monitoring subsystem comprising:
storing, according to a preset first time interval, the monitoring data as a data file corresponding to the monitoring subsystem; and
splitting, according to a preset second time interval, the data file into a plurality of data objects.

19. An electronic device, comprising a memory and a processor, the memory being configured to store a computer program, and the processor being configured to execute, under control of the computer program, the method according to claim 1.

20. A non-transitory computer-readable storage medium, storing a computer program, the computer program, when executed by a processor, implementing the method according to claim 1.
